(19) United States
(12) Patent Application Publication
(10) Pub. No.: US 2017/0329412 A1
(43) Pub. Date: Nov. 16, 2017

(54) Systems and Methods of Gesture-Based Control

(71) Applicant: Google Inc., Mountain View, CA (US)

(72) Inventors: Carsten Schwesig, San Francisco, CA (US); Ivan Poupyrev, Sunnyvale, CA (US); Constantin Schmidt, Potsdam (DE); Reto Wettach, Berlin (DE)

(21) Appl. No.: 15/596,702

(22) Filed: May 16, 2017

Related U.S. Application Data
(60) Provisional application No. 62/336,977, filed on May 16, 2016.

(51) Int. Cl. G06F 3/01; H05B 33/08; G06F 3/16

(52) U.S. Cl. CPC G06F 3/017; G06F 3/16; H05B 33/0872

(57) ABSTRACT

Systems and methods of providing gesture-based control are provided. For instance, signals indicative of a presence of a user within a first interaction zone proximate a user computing device can be received. A first feedback indication can be provided based at least in part on the signals indicative of the presence of the user in the first interaction zone. Signals indicative of a presence of the user in a second interaction zone proximate the user computing device can be received. A second feedback indication can be provided based at least in part on the signals indicative of the presence of the user in the second interaction zone. A control gesture performed by the user while in the second interaction zone can be determined. A third feedback indication can be provided based at least in part on the determined control gesture.

### FIELD

The present disclosure relates generally to user computing devices, and more particularly to providing gesture-based control by a user computing device.

### BACKGROUND

As computing devices proliferate in homes, automobiles, and offices, the need to seamlessly and intuitively control these devices becomes increasingly important. For example, a user may desire to quickly and easily control the user's media players, televisions, climate devices, etc. from wherever the user happens to be.

The use of gestures to interact with computing devices has become increasingly common. Gesture recognition techniques have successfully enabled gesture interaction with devices when these gestures are made to device surfaces, such as touch screens for phones and tablets and touch pads for desktop computers. Users, however, are increasingly desiring to interact with their devices through gestures not made to a surface, such as through in-air gestures performed proximate a computing device.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of providing gesture-based control. The method includes receiving, by a user computing device, one or more signals indicative of a presence of a user within a first interaction zone proximate the user computing device. The method further includes providing, by the user computing device, a first feedback indication based at least in part on the one or more signals indicative of a presence of the user within the first interaction zone. The method further includes receiving, by the user computing device, one or more signals indicative of a presence of the user within a second interaction zone proximate the user computing device. The method further includes providing, by the user computing device, a second feedback indication based at least in part on the one or more signals indicative of the presence of the user within the second interaction zone. The method further includes determining, by the user computing device, a control gesture performed by the user while in the second interaction zone. The method further includes providing, by the user computing device, a third feedback indication based at least in part on the determined control gesture.

Other example aspects of the present disclosure are directed to systems, apparatus, tangible, non-transitory computer-readable media, user interfaces, memory devices, and electronic devices for providing gesture-based control of a user device.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for providing gesture-based control according to example embodiments of the present disclosure;

FIG. 2 depicts an example interaction zone configuration according to example embodiments of the present disclosure;

FIG. 3 depicts a flow diagram of an example method of providing gesture-based control according to example embodiments of the present disclosure;

FIG. 4 depicts a flow diagram of an example method of providing gesture-based control according to example embodiments of the present disclosure;

FIG. 5 depicts an example user computing device according to example embodiments of the present disclosure;

FIG. 6 depicts an example user computing device according to example embodiments of the present disclosure;

FIG. 7 depicts example control gestures according to example embodiments of the present disclosure; and

FIG. 8 depicts an example system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to controlling operation of a user computing device based at least in part on one or more gestures performed by a user of the user device. For instance, a presence of a user can be detected in a first interaction zone proximate the computing device. A first feedback indication can be provided to the user in response to the detection of the user presence. The user can then be detected in a second interaction zone proximate the user device. A second feedback indication can be provided to the user in response to the detection of the user in the second interaction zone. A control gesture performed by the user can be determined while the user is in the second interaction zone, and a third feedback indication can be provided to the user based at least in part on the determined control gesture. One or more actions can then be performed based at least in part on the determined control gesture.

More particularly, the user device can be an audio playback device, such as speaker device. In some implementations, the user device can be a smartphone, tablet, wearable computing device, laptop computing device, desktop computing device, or any other suitable user device. The user device can be configured to monitor a motion of a control article (e.g. a hand of the user, an eye of the user, a head of the user, a stylus or other object controlled by the user and/or any other suitable control article) proximate the user device, and to determine one or more control gestures performed by the control article. In some implementations, the user device may include a radar module embedded within the user device configured to emit radio frequency (RF) energy in a direction of a target, and to receive return signals indicative of energy reflected back to the user device by a plurality of scattering points associated with the target. The radar module can include one or more antenna elements configured to transmit and/or receive RF energy. The received return signals can be used to detect a presence of the user and/or control article, to monitor a motion of the user and/or control article, and/or to determine one or more control gestures performed by the control article.

The user device can further be configured to provide feedback (e.g. visual feedback and/or audio feedback) to the user in response to one or more user actions proximate the use device. For instance, the user device can be configured to provide feedback to the user in response to detection of a user presence in one or more interaction zones proximate the user device. An interaction zone can be an area or region proximate the user device. The detection of a user and/or a control article within an interaction zone can trigger one or more actions by the user device.

In some implementations, the user device can have a first interaction zone proximate the user device and a second interaction zone proximate the user device. For instance, the second interaction zone can extend outward from the user device, and the first interaction zone can extend outward from the second interaction zone. The configuration of the interaction zones can be determined based at least in part on an antenna beam pattern of the one or more antenna elements associated with the radar module of the user device. For instance, the size, shape, boundaries, or other suitable characteristics of the interaction zones can be determined based at least in part on the antenna beam pattern. In some implementations, the interaction zones can partition the antenna beam pattern. For instance, the first interaction zone can correspond to a first partition of the antenna beam pattern and the second interaction zone can correspond to a second partition of the antenna beam pattern.

In some implementations, the user device can have an associated third interaction zone. The third interaction zone can extend outward from the first interaction zone. In response to detection of a user and/or control article in the third interaction zone, the user device can begin monitoring or tracking the motion of the user and/or control article. In some implementations, detection of the user in the third interaction zone can trigger a feedback indication associated with the third interaction zone to be provided.

As indicated above, the interaction zones can have predetermined boundaries based at least in part on an antenna beam pattern associated with the user device. Detection of the user and/or control article in the interaction zones can include determining a position of the user and/or control article relative to the user device. For instance, the user device can determine a radial distance of the user and/or control article from the user device, and/or spatial coordinates of the user and/or control article. Detection of the user and/or control article in a particular interaction zone within the antenna beam pattern can include comparing the relative position of the user and/or control article to the boundaries of the interaction zones. If the relative position corresponds to a location within the boundary of an interaction zone, a presence of the user and/or control article can be detected within the interaction zone.

Detection of a user and/or a control article in the first user zone can trigger a first feedback indication to the user indicative of the detection of the user and/or control article in the first interaction zone. Detection of a user and/or a control article in the second interaction zone can trigger a second feedback indication to the user indicative of the detection of the user and/or control article in the second interaction zone.

As indicated, the feedback indication can be a visual feedback indication and/or an audio feedback indication. For instance, such visual feedback indication can be provided by one or more lighting elements (e.g. LEDs or other lighting elements) associated with the user device. Operation of the lighting elements can be controlled in one or more manners to provide a feedback indication to the user. For instance, operation of the lighting elements can be controlled to provide feedback associated with one or more lighting colors, patterns, luminosities, etc. In implementations wherein audio feedback is provided, the audio feedback can correspond to one or more audio tones output by a speaker device. For instance, the one or more audio tones can include a single audio tone or a sequence of audio tones.

The feedback indications can be triggered at least in part by one or more user actions with respect to the user device. In this manner, a feedback indication to be provided to the user can be determined based at least in part on the user action. For instance, as indicated, a first feedback indication can be provided responsive to a detection of a presence of a user in the first interaction zone. The first feedback indication can be a visual and/or audio feedback interaction. For instance, the first feedback indication can include illumination of one or more lighting elements in accordance with a particular lighting color scheme, pattern, luminosity scheme, etc. Additionally or alternatively, the first feedback indication can include playback of one or more audio tones. When the user moves to the second interaction zone, a second feedback indication can be provided based at least in part on a detection of the user in the second interaction zone. The second feedback indication can be the same feedback indication as the first feedback indication, or the second feedback indication can be a different feedback indication. For instance, the second feedback indication can include playback of one or more different audio tones than the first audio feedback indication, and/or illumination of one or more lighting elements in accordance with a different lighting color scheme, pattern, luminosity scheme, etc. than the first visual feedback indication. In this manner, the various feedback indications can indicate to the user a status or context of the user and/or user action with respect to the user device.

When the user is in the second interaction zone, the user device can be configured to monitor for a control gesture performed by the control article. In this manner, the second interaction zone can correspond to an area proximate the user device wherein the user device is able to recognize control gestures performed by the user. For instance, the control gesture can be an in-air hand gesture performed by the user. The control gesture can include a motion component. For instance, in implementations wherein the control article is a hand of the user, the motion component can include a motion of the hand and/or one or more digits of the hand.

The user device can determine a performance of a control gesture by measuring a motion of the control article in real-time or near real-time as the user performs the control gesture. For instance, the user device can determine a motion profile of the control article as the control article moves within the second interaction zone. The motion profile can include measurements associated with one or more positions of the control article (e.g. a radial distance from the user device, one or more spatial coordinates of the control article, etc.), one or more velocities of the control article, one or more temporal changes associated with the position and/or velocity of the control article, and/or other characteristics associated with the control article. The control gesture as performed by the user can be recognized as a control gesture from a predefined set of control gestures associated with the user device. For instance, the user device can include a predefined set of control gestures mapped to one or more actions to be performed by the user device in response to detection of a performance of the control gestures by a user. In this manner, the user can perform a control gesture from the predefined set to prompt the user device to perform one or more actions.

The user device can provide a third feedback indication to the user in response to detection of a control gesture performed by the user. The third feedback indication can be a visual feedback indication and/or an audio feedback indication. In some implementations, the third feedback indication can be determined based at least in part on the detected control gesture. For instance, the third feedback indication can correspond to a particular control gesture. In this manner, each control gesture from the predefined set of control gestures can have a corresponding third feedback indication.

The user device can perform one or more actions in response to detection of a control gesture. For instance, the one or more actions can be associated with a media playback operation. For instance, the one or more actions can include operations such as playing media (e.g. song, video, etc.), pausing media, playing the next item on a playlist, playing the previous item on a playlist, playing a random media file, playing a song of a different genre, controlling a volume of the media playback, favoriting or unfavoriting a media file, and/or any other suitable media playback operation. As indicated, the one or more actions to be performed can be mapped to predefined control gestures. For instance, a play or pause operation can be mapped to a first control gesture, increasing volume can be mapped to a second control gesture, and decreasing volume can be mapped to a third control gesture. In this manner, when performance of a control gesture is detected, the user device can determine the corresponding action(s) to perform, and can perform the actions.

In some implementations, the feedback indications can be independent of one or more actions performed by the user device. For instance, the third feedback indication can be independent of the action performed in response to detection of a performance of a control gesture. For instance, the third feedback indication can include visual and/or audio feedback in addition to the performance of the action. As an example, in implementations wherein the actions to be performed in response to the control gestures are associated with media playback control, the third feedback indication can include illuminating one or more lighting elements and/or playing back one or more audio tones in addition to performing the media playback control action. In this manner, the one or more audio tones can be separate and distinct audio tones from a media file being played in response to a control gesture.

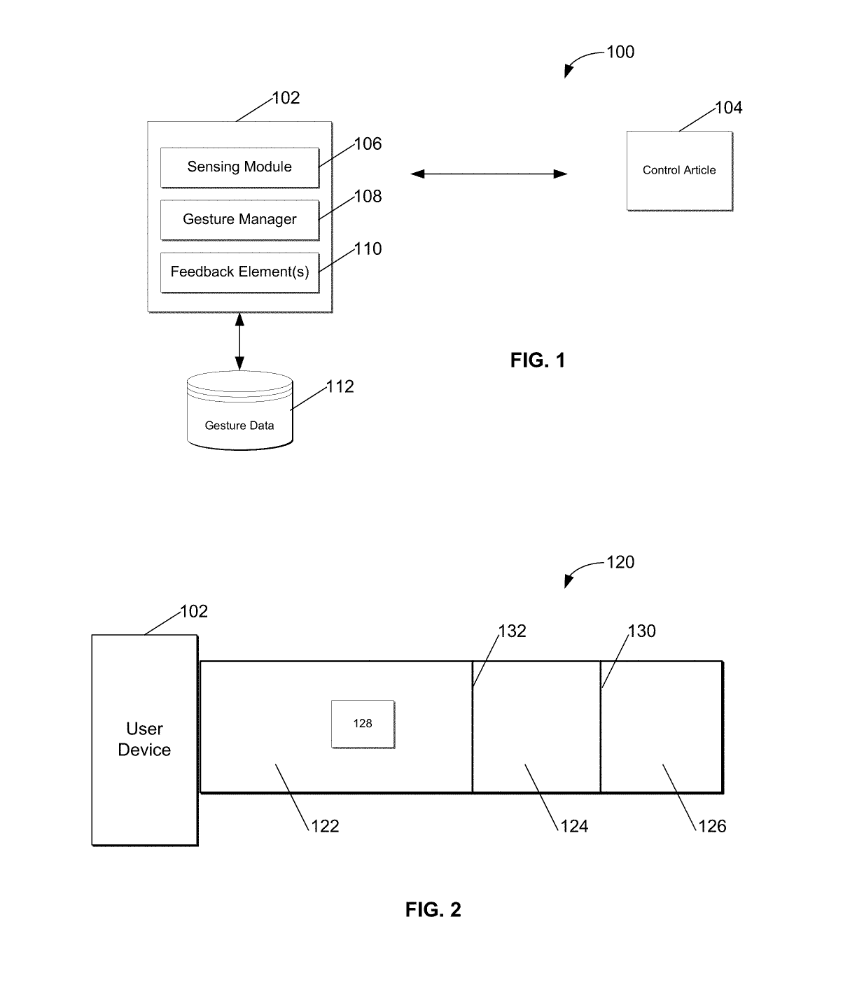

With reference now to the figures, example embodiments of the present disclosure will be discussed in greater detail. For instance, FIG. 1 depicts an example system 100 for providing gesture-based control according to example embodiments of the present disclosure. System 100 includes a user device 102 and a control article 104. Control article 104 can include any suitable article or object capable of performing control gestures recognizable by user device 102. In some implementations, control article can be a limb or other body part associated with a user. For instance, control article 104 can be a hand, head, eye, etc. of the user. In some implementations, control article can be an object capable of being carried by the user, such as a stylus or other object.

User device 102 can be any suitable user computing device, such as a smartphone, tablet, wearable computing device, laptop computing device, desktop computing device, or any other suitable user computing device. In some implementations, user device 102 can be a media device (e.g. speaker device) configured to provide media playback. User device 102 includes a sensing module 106, a gesture manager 108, and one or more feedback elements 110. In some implementations, sensing module 106 can include one or more sensing devices such as one or more optical cameras, infrared cameras, capacitive sensors, and/or various other suitable sensing devices. In some implementations, sensing module 106 can be a radar module. For instance, sensing module 106 can include one or more antenna elements configured to emit and/or receive RF energy signals. For instance, such RF energy signals can be propagated in a direction determined by an antenna beam pattern formed by the one or more antenna elements. In some implementations, the RF energy signals can be propagated in a general direction of control article 104. In this manner, the propagated energy signals can be absorbed or scattered by control article 104. The energy signals coherently scattered back in a direction of user device 102 can be intercepted by the (receiving) antenna elements.

The received energy signals can be provided to gesture manager 108. Gesture manager 108 can be configured to process the received energy signals to recognize a control gesture performed by control article 104. For instance, gesture manager 108 can determine a motion profile associated with control article 104. The motion profile can include information associated with the motion of the control article during one or more time periods. For instance, the motion profile can include velocity data, location data (e.g. radial distance, spatial coordinates), and/or other data associated with the motion of the control article during the one or more time periods. In this manner, temporal changes associated with the motion of the control article can be tracked or otherwise monitored.

The motion profile can be used to determine a control gesture (e.g. in-air hand gesture) performed by control article 104. For instance, gesture manager 108 can access gesture data 112 to match a movement pattern performed by control article 104 with a control gesture associated with gesture data 112. In particular, gesture data 112 can include a set of predetermined control gestures. Each predetermined control gesture can be mapped to an action or operation to be performed by user device 102 in response to recognition of a movement pattern performed by control article 104 that matches the control gesture. In this manner, gesture manager 108 can compare the determined motion profile associated with control article 104 against gesture data 112 to determine if the motion profile matches a predetermined control gesture. When the motion profile matches a control gesture, user device 102 can perform the action or operation corresponding to the matched control gesture.

As indicated above, the control gestures can include a motion component. For instance, in implementations wherein control article 104 is a hand of the user, a control gesture may correspond to some predetermined movement of the hand and/or the digits of the hand, such as hand and/or digit translation, rotation, extension, flexion, abduction, opposition or other movement. As another example, in implementations wherein control article 104 is the head of the user, a control gesture can correspond to some predetermined movement of the head, such as an extension, rotation, bending, flexion or other movement. As yet another example, in implementations, wherein control article 104 is an external object, such as a stylus carried by the user, a control gesture can correspond to some predetermined motion pattern of the stylus. In some implementations, gesture manager 108 can be configured to recognize gestures performed by a plurality of control articles. For instance, gesture manager 108 can be configured to recognize a first control gesture as performed by a user hand, and a second control gesture performed by a user head. In this manner, gesture data 112 can include control gestures associated with each of the plurality of control articles.

Movement patterns performed by various components of control article 104 can be observed individually. For instance, movements associated with each finger of a hand can be individually monitored. In some implementations, the motion of one or more components of control article 104 can be tracked relative to one or more other components of control article 104. For instance, movement of a first digit of a hand can be tracked relative to movement of a second digit of the hand.

In some implementations, gesture data 112 can include data associated with a representative model of control article 104. For instance, gesture data 112 can include a model of a human hand that provides relational positional data for a hand and/or digits of the hand. In some implementations, such control article model can facilitate predictive tracking even when parts of control article 104 are not visible. For instance, in such implementations, signals associated with the visible parts of control article 104 can be used in conjunction with the control article model and/or past observations of control article 104 to determine one or more likely positions of the parts of control article 104 that are not currently visible.

User device 102 can be configured to provide feedback to the user in response to one or more detected actions performed by the user. For instance, user device 102 can be configured to provide one or more feedback indications to the user via feedback element(s) 110. Feedback element(s) 110 can include one or more visual feedback elements, such as one or more lighting elements. The lighting elements can include any suitable lighting elements, such as LEDs and/or other lighting elements. For instance, the LEDs can include one or more addressable RBBW LEDs, one or more pairs of white and color LEDs, or other suitable LED arrangement. Feedback element(s) 110 can also include one or more audio feedback elements, such as one or more speaker elements.

One or more feedback indications (e.g. visual and/or audio feedback indications) can be provided to the user, for instance, in response to a detection by user device 102 of control article 104 within one or more interaction zones proximate user device 102. One or more feedback indications can further be provided to the user, for instance, in response to detection of a control gesture performed by control article 104. As indicated, the visual feedback indication can include controlling operation of the lighting elements to provide a feedback indication, for instance, in accordance with some lighting color, pattern, and/or luminosity scheme. In some implementations, the lighting elements can be controlled in accordance with a pulse width modulation control scheme. The audio feedback indication can include one or more tones played using a speaker device associated with user device 102. For instance, the audio feedback indication can include playback of a single audio tone or a sequence of audio tones.

In some implementations, user device 102 may include a display device configured to display a user interface associated with user device 102. In such implementations, feedback element(s) 110 can be independent from the display device. For instance, the lighting elements of feedback element(s) 110 can be additional lighting elements not included within the display device.

In some implementations, a user action can correspond to a particular feedback indication. For instance, a first feedback indication can be provided in response to detection of the user within a first interaction zone proximate user device 102, and a second feedback indication can be provided in response to detection of the user within a second interaction zone proximate user device 102. A third feedback indication can be provided in response to detection of a control gesture performed by control article 104. In some implementations, the third feedback indication can be determined based at least in part on the detected control gesture such that each control gesture associated with gesture data 112 has a corresponding feedback indication. In this manner, when a particular performance of a particular control gesture is detected, user device 102 can provide the corresponding feedback indication using feedback element(s) 110.

FIG. 2 depicts a diagram depicting example interaction zones 120 associated with user device 102 according to example embodiments of the present disclosure. Interaction zones 120 include an interactive zone 122, a reactive zone 124, and a tracking zone 126. As shown, interactive zone 122 can correspond to a near zone, reactive zone 124 can be an intermediate zone, and tracking zone 126 can be a far zone. The interaction zones 120 can be determined based at least in part on sensing module 106. For instance, the interaction zone 120 can be determined based at least in part on an antenna beam pattern formed by the one or more antenna elements of sensing module 106. The antenna beam pattern can represent an area proximate user device 102 in which user device 102 is capable of detecting objects. For instance, the antenna elements can emit RF energy signals in the general shape of the antenna beam pattern, and objects within the antenna beam pattern can be observed by user device 102. The interaction zones 120 can form one or more partitions of the antenna beam pattern. In this manner, the shape and size of the interaction zones 120 can be determined based at least in part on the antenna beam pattern. For instance, interactive zone 122 can form a first partition of the antenna beam pattern, reactive zone 124 can form a second partition of the antenna beam pattern, and tracking zone 126 can form a third partition of the antenna beam pattern. In this manner, the various partitions defining the interaction zones 120 can substantially define the antenna beam pattern. It will be appreciated that various other interaction zone arrangements can be used without deviating from the scope of the present disclosure.

As shown, interactive zone 122 extends outwardly from user device 102, reactive zone 124 extends outwardly from interactive zone 122, and tracking zone 126 extends outwardly from reactive zone 124. Detection of a control article 128 within the interaction zones 120 can trigger one or more actions by user device 102. Control article 128 can correspond to control article 104 of FIG. 1 or other control article. For instance, control article 128 can a hand of a user of user device 102.

When control article 128 enters tracking zone 126, user device 102 can detect control article 128. For instance, control article 102 can be detected based at least in part on the return signals received by user device 102. Such return signals can be indicative of control article 128. In some implementations, when control article 128 is detected within tracking zone 126, user device 102 can begin monitoring the motion of control article 128. For instance, user device 102 can determine a motion profile associated with control article 128. When control article 128 crosses threshold 130, the presence of control article 128 can be detected in reactive zone 124. For instance, user device 102 can detect the presence of control article 128 within reactive zone 124 by determining a location of control article 128 and comparing the location to a location of threshold 130 and/or one or more boundaries of reactive zone 124. User device 102 can continue monitoring the motion of control article 128 while control article 128 is present within reactive zone 124.

As indicated, user device 102 can provide a first feedback indication to the user in response to the detection of control article 128 within reactive zone 124. For instance, user device 102 can provide visual and/or audio feedback to the user in response to the detection of control article 128 within reactive zone 124. In some implementations, user device 102 can provide a visual feedback indication that includes illumination of one or more lighting elements. In some implementations, the luminosity or brightness of the lighting elements can vary with the distance of control article 128 from user device 102. For instance, when control article 128 crosses threshold 130, user device 102 can control operation of one or more lighting elements to illuminate at an initial brightness level. As control article 128 approaches user device 102 within reactive zone 124, the brightness level can be gradually increased. If control article 128 retreats from user device 102, the brightness level can be gradually decreased. In some implementations, the first feedback indication can be continuously provided to the user at least until control article 128 exits reactive zone 124. For instance, if control article 128 exits reactive zone 124 across threshold 130, the first feedback indication can be ceased, and operation of the lighting elements can be controlled to turn off. In some implementations, operation of the lighting elements can be controlled to gradually turn off.

User device 102 can provide a second feedback indication to the user in response to detection of control article 128 within interactive zone 122. User device 102 can detect the presence of control article 128 within interactive zone 122 by comparing a location of control article 128 (e.g. as determined by user device 102) with threshold 132 and/or one or more boundaries of interactive zone 122. The second feedback indication can be different than the first feedback indication. For instance, the second feedback indication can include controlling one or more additional lighting elements to illuminate. In some implementations, the first feedback indication can continue in conjunction with the second feedback indication. For instance, the first feedback indication can include illuminating one or more first lighting elements, and the second feedback indication can include illuminating one or more second lighting elements. The one or more first lighting elements can continue to be illuminated as the one or more second lighting elements are illuminated.

When control article 128 crosses threshold 132, user device 102 can begin monitoring for control gestures performed by control article 128. User device 102 can monitor for control gestures performed by control article 128 while control article 128 is located within interactive zone 122. When control article 128 leaves interactive zone 122, user device 102 can cease monitoring for control gestures. For instance, user device 102 can compare the motion profile associated with control article 128 to gesture data 112 to determine a match between a movement pattern of control article 128 and a control gesture associated with gesture data 112. If a match is determined, user device 102 can interpret the movement pattern of control article 128 as a control gesture, and can determine one or more actions or operations to perform in response to the performance of the control gesture. In some implementations, a match can be found between the movement pattern and a control gesture by based at least in part on a level at which user device 102 is certain that the movement pattern was intended to be a control gesture. For instance, user device 102 can compare the movement pattern against gesture data 112 to determine a percentage of likelihood (e.g. certainty) that the movement pattern was intended to be a control gesture. If the percentage of likelihood is greater than a threshold, a match can be determined.

User device 102 can provide a third feedback indication to the user in response to detection of a performance of a control gesture by control article 128. The third feedback indication can be different than the first and second feedback indications. For instance, the third feedback indication can include changing a color, luminosity, or pattern associated with the second feedback indication. In some implementations, the third feedback indication can include controlling one or more additional lighting elements to illuminate in addition or alternatively to the one or more first lighting elements and/or the one or more second lighting elements. The third feedback indication can further include an audio feedback indication that includes one or more audio tones. As indicated above, the third feedback indication can correspond to a particular control gesture and/or action to be performed in response to detection of the control gesture. For instance, in some implementations, the third feedback indication can mimic the control gesture to provide an indication to the user that the appropriate control gesture was determined.

The feedback indications can provide an affordance to the user associated with the interaction of the user with user device 102. For instance, the first feedback indication can provide an indication to the user that user device 102 has detected control article 128 and/or that user device 102 is tracking the motion of control article 128. For instance, in implementations wherein the lighting elements are controlled to gradually vary in brightness with the distance of control article 128 to user device 102, the gradual variation can be implemented to provide a relational context to the user associated with the interaction of the user with user device 102. For instance, the gradual variation can be implemented to provide a continuous or seemingly continuous variation to the user as control article 128 is moved with respect to user device 102. As another example, the third feedback indication can provide an affordance to the user associated with the control gesture and/or the action to be performed in response to detection of the control gesture.

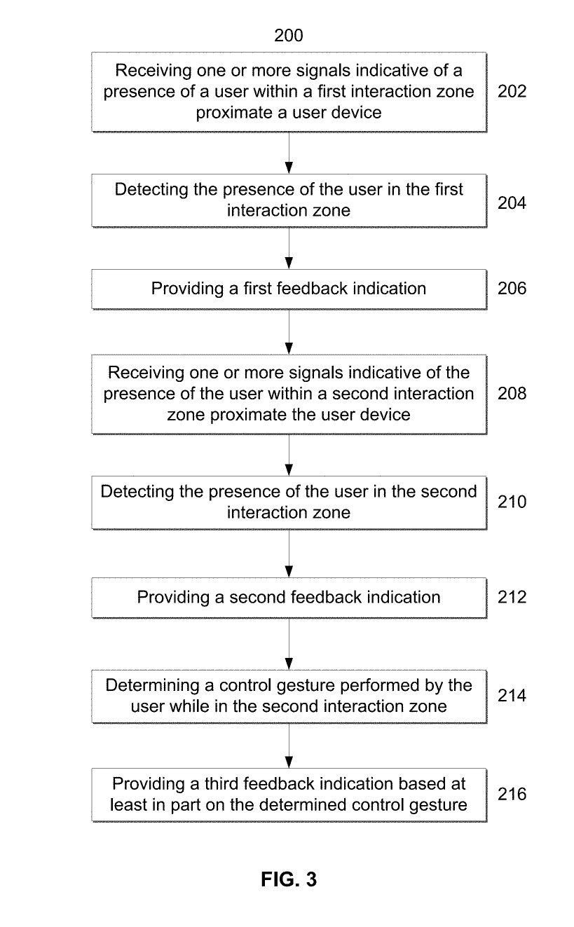

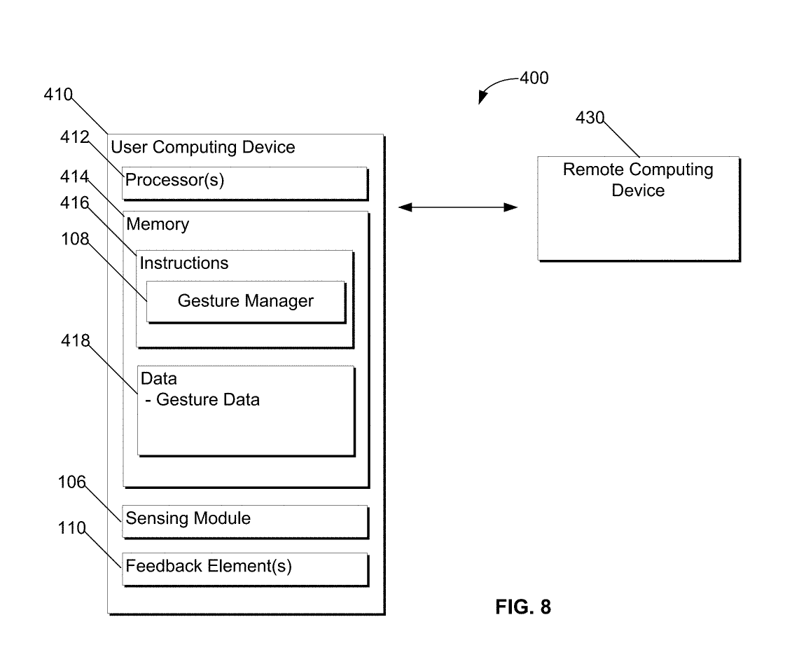

FIG. 3 depicts a flow diagram of an example method (200) of providing gesture-based control by a user device. Method (200) can be implemented by one or more computing devices, such as one or more of the computing devices depicted in FIG. 8. In particular implementations, the method (200) can be implemented at least in part by the gesture manager 108 depicted in FIG. 1. In addition, FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), method (200) can include receiving one or more signals indicative of a presence of a user within a first interaction zone proximate a user device. For instance, the first interaction zone can correspond to reactive zone 124 depicted in FIG. 2. The one or more signals can include one or more signals received by one or more antenna elements associated with a radar module included in or otherwise associated with the user device. For instance, the radar module can be configured to emit RF energy and to receive return signals. The emitted energy can be associated with a radiation pattern formed by the antenna elements. The return signals can include energy reflected by one or more scattering points of a target in the direction of the energy emission. For instance the target can be a control article associated with a user of the user device. The control article can be a limb or other body part of the user or can be an external object or device carried and/or manipulated by the user. It will be appreciated that the one or more signals can be associated with various other sensing techniques, such as optical imaging, infrared imaging, capacitive sensing, and/or other sensing techniques.

At (204), method (200) can include detecting the presence of the user in the first interaction zone. For instance, the signals can be processed or otherwise analyzed to determine a presence of the user within the first interaction zone. In particular, a location of the user and/or control article can be determined at least in part from the one or more signals. The location can be compared to a location (e.g. one or more predetermined boundaries) of the first interaction zone to determine if the user and/or control article is located within the first interaction zone. As indicated above, the first interaction zone can define a region or area proximate the user device. For instance, the first interaction zone can include predetermined boundaries relative to the user device. In some implementations, the size, shape, boundaries, etc. of the first interaction zone can be determined based at least in part on the antenna radiation pattern associated with the antenna elements.

At (206), method (200) can include providing a first feedback indication in response to detecting the user and/or control article within the first interaction zone. For instance, the first feedback indication can include a visual and/or audio feedback indication. In some implementations, providing the first feedback indication can include controlling operation of one or more lighting elements to illuminate in accordance with one or more lighting colors, patterns, luminosities, etc. As indicated above, in some implementations, providing the first feedback indication can include controlling the luminosity of one or more lighting elements to vary with the distance between the user and/or control article and the user device. For instance, the variation can be a gradual variation configured to provide a seemingly continuous variation as the distance between user and/or control article and the user device varies. Additionally or alternatively, providing the first feedback indication can include controlling operation of one or more speaker devices associated with the user device to play one or more audio tones.

At (208), method (200) can include receiving one or more signals indicative of the presence of the user within a second interaction zone proximate the user device. For instance, the first interaction zone can correspond to interactive zone 122 depicted in FIG. 2. The second interaction zone can define a region or area proximate the user device. For instance, in some implementations, the second interaction zone can extend outward from the user device. Similar to the first interaction zone, the second interaction zone can include predetermined boundaries, the configuration of which can be determined based at least in part on the radiation pattern associated with the antenna elements. At (210), method (200) can include detecting the presence of the user in the second interaction zone. For instance, a location of the user and/or control article can be determined and compared to a location of the second interaction zone to determine a presence of the user and/or control article in the second interaction zone.

At (212), method (200) can include providing a second feedback indication in response to detecting the user in the second interaction zone. The second feedback indication can include a visual feedback indication and/or an audio feedback indication. In some implementations, the second feedback indication can be provided in addition to the first feedback indication such that the first and second feedback indications are provided simultaneously. For instance, the second feedback indication can include an illumination of one or more additional lighting elements than the first feedback indication. The one or more additional lighting elements can be illuminated in accordance with one or more lighting colors, patterns luminosities, etc.

At (214), method (200) can include determining a control gesture performed by the user while in the second interaction zone. For instance, the user and/or control article can perform a movement pattern while located in the second interaction zone. The movement pattern determined by the user device and compared against one or more predetermined control gestures associated with the user device. If a match is found, the movement pattern can be interpreted as a control gesture.

At (216), method (200) can include providing a third feedback indication based at least in part on the determined control gesture. The third feedback indication can be a visual and/or audio feedback indication. As indicated above, the third feedback indication can be a different feedback indication than the first and second feedback indications. For instance, the third feedback indication can include a change in lighting color, pattern, luminosity, etc. from the first and/or second feedback indications.

The third feedback indication can be determined based at least in part on a particular control gesture. In this manner, each control gesture from the predetermined set of control gestures can have a corresponding third feedback indication. In some implementations, the third feedback indication can be configured to mimic the control gesture and/or an action to be performed in response to the control gesture. For instance, the third feedback indication can include illumination of one or more lighting elements and/or playback of one or more audio tones in a manner that simulates or otherwise represents the control gesture and/or action to be performed in response to the control gesture.

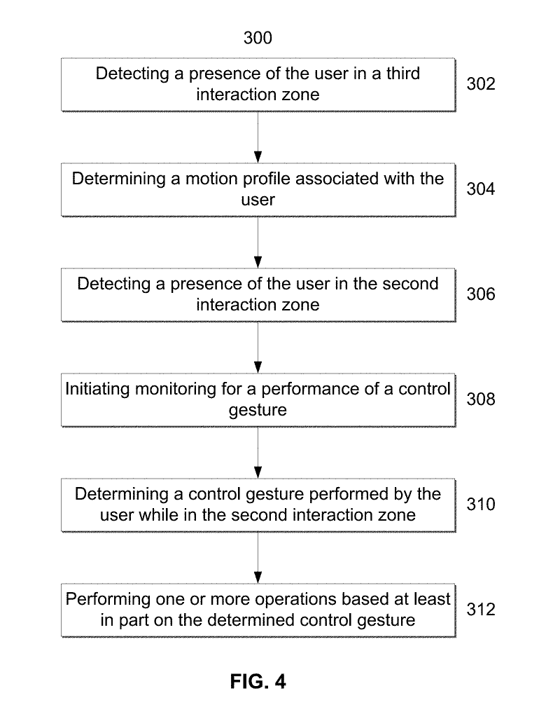

FIG. 4 depicts a flow diagram of an example method (300) of providing gesture-based control of a user device according to example embodiments of the present disclosure. Method (300) can be implemented by one or more computing devices, such as one or more of the computing devices depicted in FIG. 8. In particular implementations, the method (300) can be implemented at least in part by the gesture manager 108 depicted in FIG. 1. In addition, FIG. 4 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (302), method (300) can include detecting a presence of the user in a third interaction zone. For instance, the third interaction zone can correspond to tracking zone 126 depicted in FIG. 2. Similar to the first and second interaction zones described with reference to FIG. 3, the third interaction zone can include predetermined boundaries, the configuration of which can be determined by the antenna radiation pattern associated with the antenna elements of the user device.

At (304), method (300) can include determining a motion profile associated with the user and/or control article. For instance, the motion profile can be determined in response to detecting the presence of the user and/or control article in the third interaction zone. The motion profile can be determined at least in part from the return signals received by the antenna elements of the user device. For instance, the return signals can be processed to determine one or more velocities, locations (e.g. radial distance, spatial coordinates and/or other location data), etc. of the user and/or control article. In particular, temporal changes to the signal can be used to determine a displacement of the user and/or control article over time as the user and/or control article moves throughout the first, second, and third interaction zones. As indicated above, in some implementations, the movements of various components of the control article (e.g. digits of a hand) can also be tracked and included in the motion profile. In this manner, the motion of the user and/or control article can be tracked in real-time or near real-time as the user and/or control article moves.

At (306), method (300) can include detecting a presence of the user in the second interaction zone. At (308), method (300) can include initiating monitoring for a performance of a control gesture. For instance, the monitoring for a performance of a control gesture can be initiated in response to detection of the user in the second interaction zone. In this manner, the user device can monitor for control gestures for the duration that the user and/or control article is present in the second interaction zone. For instance, monitoring for a performance of a control gesture can include comparing a movement pattern of the control article as specified in the motion profile to a set of predetermined control gestures.

At (308), method (300) can include determining a control gesture performed by the user while in the second interaction zone. For instance, the movement pattern can be compared to the set of predetermined control gestures and a match can be determined. In some implementations, a level of certainty of a match can be determined. For instance, the level of certainty can quantify how certain the user device is that the user intended to perform a particular control gesture. If the level of certainty is greater than a certainty threshold, a match can be determined, and the movement pattern can be interpreted as a control gesture.

At (310), method (300) can include performing one or more operations based at least in part on the determined control gesture. For instance, each predetermined control gesture can have a corresponding action to be performed in response to detection of a performance of the control gesture by the user. In this manner, the user can perform a control gesture to prompt the user device to perform a particular operation. As indicated, in some implementations, the operations can be associated with media playback.

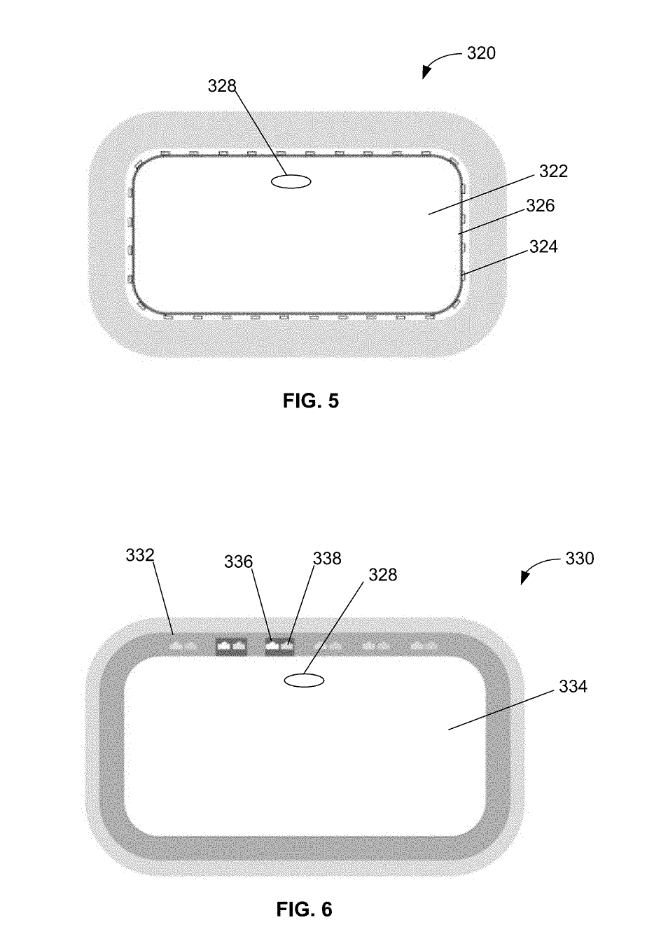

FIG. 5 depicts an example user computing device 320 according to example embodiments of the present disclosure. In particular, FIG. 5 depicts a front view of a face 322 of user computing device 320. For instance, one or more interaction zones according to example embodiments of the present disclosure can extend outward from face 322 of user computing device 320. In some implementations, user computing device 320 can correspond to a speaker device or other suitable user computing device. As shown, user computing device 320 includes feedback elements 324. Feedback elements 324 can form a ring or band around at least a portion of face 322. Feedback elements 322 can be lighting elements. In particular, feedback elements 322 can include LED lighting elements. In some implementations, the LED lighting elements can include addressable RGBW LEDs. In some implementations, the lighting elements can be associated with an LED strip. The lighting elements may have one or more associated diffusor elements disposed over at least a portion of the lighting elements. The diffusor elements can be configured to diffuse light emitted by the lighting elements. Such diffusor elements can include sanded acrylic diffusor elements or other suitable diffusor elements. As shown in FIG. 5, the diffusor element(s) can correspond to an acrylic strip 326 attached (e.g. glued) to the lighting elements (e.g. LED strip). In this manner, an outer edge of acrylic strip 326 can be sanded to facilitate a desired light diffusion associated with the lighting elements.

As indicated above, feedback elements 324 can provide one or more feedback indications to a user in response to a detection of a control article in one or more interaction zones extending outward, for instance, from face 322. Such feedback indications can include an emission of light from feedback elements 324 in accordance with one or more lighting schemes. For instance, a color, pattern, brightness, etc. of light emitted by feedback elements 324 can be adjusted as the detected control article moves within the interaction zones with respect to user computing device 320. As an example, the lighting elements can be configured to gradually increase a luminosity or brightness of light emitted by the lighting elements as the control article approaches user computing device 320 (e.g. within the interaction zones). The lighting elements can further be configured to gradually decrease a luminosity or brightness of light emitted by the lighting elements as the control article retreats from user computing device 320 (e.g. within the interaction zones). As another example, the lighting elements can be configured to change a color of the light emitted by the lighting elements as the control article moves with respect to user computing device 320. In some implementations, the lighting elements can be configured to provide a feedback indication upon detection of entry into one or more of the interaction zones. As indicated, such feedback indication can include a change in luminosity or brightness, color, and/or pattern of emitted light. For instance, a feedback indication can include an illumination of one or more lighting elements during one or more time periods.

User computing device 320 further includes feedback element 328. Feedback element 328 can include one or more lighting elements. In some implementations, feedback element 328 can be configured to provide one or more feedback indications alternatively or in addition to a feedback indication provided by feedback elements 324. For instance, in some implementations, feedback element 328 can be configured to emit light in response to a detection of the control article in one or more interaction zones. Feedback element 328 can be configured to emit light in accordance with one or more lighting color, brightness, and/or pattern schemes. As indicated above, feedback elements 324 and/or feedback element 328 can further be configured to provide one or more feedback indications in response to detection of a control gesture performed by the control article.

FIG. 6 depicts a front view of another example user computing device 330 according to example embodiments of the present disclosure. User computing device 330 includes feedback elements 332. Feedback elements 332 can be lighting elements. In particular, the lighting elements can include a plurality of LED pairs. For instance, such LED pair can include a white LED 336 and an RGB LED 338. In some implementations, such LED pairs can include low profile side LEDs. The lighting elements can be attached (e.g. surface mounted) to a printed circuit board that forms a ring or band around at least a portion of a face 334 of user computing device 330. The lighting elements can be controlled using one or more control devices, such as one or more pulse width modulation controllers. User computing device 330 can further include an acrylic (or other suitable material) ring configured to diffuse light emitted by the lighting elements. The acrylic ring can be attached to or otherwise disposed over the printed circuit board. In some implementations, the acrylic ring can include cutouts for the lighting elements, such that the lighting elements can be positioned within the cutouts. Similar to feedback elements 324 of user computing device 320, feedback elements 332 can be configured to provide one or more feedback indications to a user in accordance with example embodiments of the present disclosure.

It will be appreciated that the feedback element configurations discussed with regard to FIGS. 5 and 6 are discussed for illustrative purposes only. In particular, it will be appreciated that various other suitable feedback element configurations can be used having various other feedback element types, amounts, configurations, etc. In addition, such feedback elements can be configured to provide various other suitable types of feedback indications in response to various other suitable actions or events.

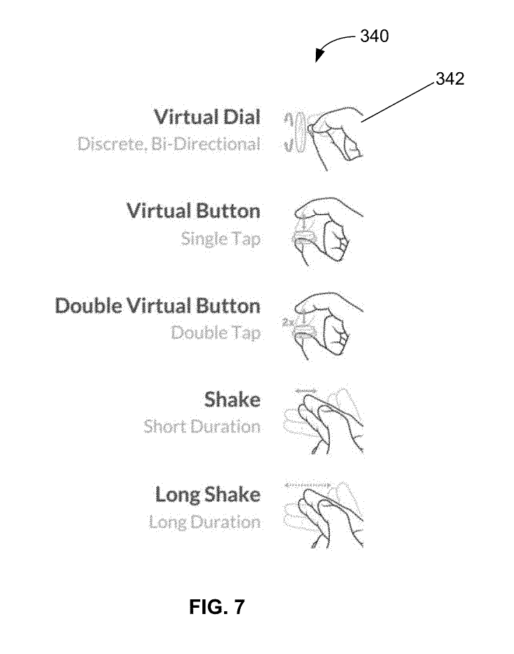

FIG. 7 depicts an example control gesture set 340 according to example embodiments of the present disclosure. As shown, the control gesture set 340 includes a plurality of control gestures that can be performed by a representative control article 342 (e.g. human hand). In particular, control gesture set 340 includes a virtual dial control gesture, a virtual button control gesture, a double virtual button control gesture, a shake control gesture, and a long shake control gesture. It will be appreciated that various other suitable control gestures can be included.

As shown, the control gestures in control gesture set 340 each include a motion component by the control article. For instance, the virtual dial control gesture can include a rotation of a thumb and finger of a human hand to mimic a turning of a dial or knob. As another example, the virtual button control gesture can include a movement of the thumb or a finger towards each other to mimic the pressing of a button. In this manner, the double virtual tap motion can include such motion twice in a row to mimic a double press of a button. As yet another example, the shake control gesture can include a motion of one or more fingers in a back and forth motion to mimic a shaking motion. In this manner, the long shake control gesture can include a longer back and forth motion of the one or more fingers to mimic a longer shaking motion.

As indicated above, when a user computing device according to example embodiments of the present disclosure detects a performance of a control gesture included in control gesture set 340 by a suitable control article (e.g. a hand of a user proximate the user computing device), the user computing device can perform one or more actions. In particular, the control gestures in control gesture set 340 can be mapped to one or more actions to be performed in response to detection of a control gesture in control gesture set by a control article.

As an example, the virtual dial control gesture can be mapped to an action associated with a volume adjustment associated with media playback associated with a user computing device. For instance, the volume can be increased in response to a detection of a suitable rotation of a thumb and finger in a first direction (e.g. clockwise), and the volume can be decreased in response to a detection of a suitable rotation of a thumb and finger in a second direction (e.g. counter-clockwise). As another example, the virtual button control gesture can be mapped to a play/pause control gesture associated with the media playback. For instance, if media is currently being played, the media can be paused in response to a detection of a performance of the virtual button control gesture, and vice versa. The double virtual button control gesture can be mapped to a favorite or unfavorite action. For instance, in response to a detection of a performance of the double virtual tap control gesture, the user computing device can favorite media currently being played or unfavorite the media currently being played (e.g. if the media has already been favorited). As yet another example, the shake control gesture can be mapped to a skip action, such that in response to a detection of a performance of the shake control gesture, a different media file is played (e.g. the next song in a playlist). As yet another example, the long shake can be mapped to an action wherein “something different” is played by the user computing device. For instance, in response to a detection of a performance of the long shake control gesture, the user computing device can play a different genre of music, or play a random song. It will be appreciated that various other suitable actions can be mapped to control gesture set 340.

FIG. 8 depicts an example computing system 400 that can be used to implement the methods and systems according to example aspects of the present disclosure. The system 400 can be implemented using a single computing device, or the system 400 can be implemented using a client-server architecture wherein a user computing device communicates with one or more remote computing devices 430 over a network. The system 400 can be implemented using other suitable architectures.

As indicated, the system 400 includes user computing device 410. The user computing device 410 can be any suitable type of computing device, such as a general purpose computer, special purpose computer, speaker device, laptop, desktop, mobile device, navigation system, smartphone, tablet, wearable computing device, a display with one or more processors, or other suitable computing device. The user computing device 410 can have one or more processors 412 and one or more memory devices 414. The user computing device 410 can also include a network interface used to communicate with one or more remote computing devices 430 over a network. The network interface can include any suitable components for interfacing with one more networks, including for example, transmitters, receivers, ports, controllers, antennas, or other suitable components.

The one or more processors 412 can include any suitable processing device, such as a microprocessor, microcontroller, integrated circuit, logic device, graphics processing unit (GPU) dedicated to efficiently rendering images or performing other specialized calculations, or other suitable processing device. The one or more memory devices 414 can include one or more computer-readable media, including, but not limited to, non-transitory computer-readable media, RAM, ROM, hard drives, flash drives, or other memory devices. The one or more memory devices 414 can store information accessible by the one or more processors 412, including computer-readable instructions 416 that can be executed by the one or more processors 412. The instructions 416 can be any set of instructions that when executed by the one or more processors 412, cause the one or more processors 412 to perform operations. For instance, the instructions 416 can be executed by the one or more processors 412 to implement, for instance, the gesture manager 108 described with reference to FIG. 1.

As shown in FIG. 8, the one or more memory devices 414 can also store data 418 that can be retrieved, manipulated, created, or stored by the one or more processors 412. The data 418 can include, for instance, gesture data 112, and other data. The data 418 can be stored in one or more databases. In various implementations, the one or more databases can be implemented within user computing device 410, connected to the user computing device 410 by a high bandwidth LAN or WAN, and/or connected to user computing device 410 through network 440. The one or more databases can be split up so that they are located in multiple locales.

The user computing device 410 of FIG. 8 can include various input/output devices for providing and receiving information from a user. For instance, user computing device 410 includes feedback element(s) 110. Feedback element(s) 110 can include one or more lighting elements and/or one or more speaker elements. In some implementations, user computing device can further include other input/output devices, such as a touch screen, touch pad, data entry keys, speakers, and/or a microphone suitable for voice recognition. For instance, the user computing device 410 can have a display device 415 for presenting a user interface for displaying media content according to example aspects of the present disclosure.

The user computing device 410 can exchange data with one or more remote computing devices 430 over a network. In some implementations, a remote computing device 430 can be server, such as a web server. Although only one remote computing device 430 is illustrated in FIG. 8, any number of remote computing devices 430 can be connected to the user computing device 410 over the network.

The remote computing device(s) 430 can be implemented using any suitable computing device(s). Similar to the user computing device 410, a remote computing device 430 can include one or more processor(s) 432 and a memory 434. The one or more processor(s) 432 can include one or more central processing units (CPUs), and/or other processing devices. The memory 434 can include one or more computer-readable media and can store information accessible by the one or more processors 432, including instructions 436 that can be executed by the one or more processors 432 and data 438.

The remote computing device 430 can also include a network interface used to communicate with one or more remote computing devices (e.g. user computing device 410) over the network. The network interface can include any suitable components for interfacing with one more networks, including for example, transmitters, receivers, ports, controllers, antennas, or other suitable components.

The network can be any type of communications network, such as a local area network (e.g. intranet), wide area network (e.g. Internet), cellular network, or some combination thereof. The network can also include a direct connection between a remote computing device 430 and the user computing device 410. In general, communication between the user computing device 410 and a remote computing device 430 can be carried via network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of providing gesture-based control, the method comprising:
receiving, by a user computing device, one or more signals indicative of a presence of a user within a first interaction zone proximate the user computing device;
providing, by the user computing device, a first feedback indication based at least in part on the one or more signals indicative of a presence of the user within the first interaction zone;
receiving, by the user computing device, one or more signals indicative of a presence of the user within a second interaction zone proximate the user computing device;
providing, by the user computing device, a second feedback indication based at least in part on the one or more signals indicative of the presence of the user within the second interaction zone;
determining, by the user computing device, a control gesture performed by the user while in the second interaction zone; and
providing, by the user computing device, a third feedback indication based at least in part on the determined control gesture.

2. The computer-implemented method of claim 1, further comprising:
identifying, by the user computing device, one or more actions to be performed based at least in part on the determined control gesture; and
performing, by the user computing device, the one or more actions.

3. The computer-implemented method of claim 1, wherein the second interaction zone comprises a predefined region relative to the user computing device wherein the user computing device can determine a control gesture performed by the user.

4. The computer-implemented method of claim 1, wherein the user computing device comprises a speaker device.

5. The computer-implemented method of claim 1, wherein the first feedback indication comprises a visual feedback indication or an audio feedback indication.

6. The computer-implemented method of claim 5, wherein providing, by the user computing device, a first feedback indication comprises controlling operation of one or more lighting elements associated with the user computing device to provide the first feedback indication.

7. The computer-implemented method of claim 1, wherein the third feedback indication comprises an audio indication.

8. The computer-implemented method of claim 7, wherein providing, by the user computing device, a third feedback indication comprises controlling operation of an audio playback device to provide the third feedback indication.

9. The computer-implemented method of claim 7, wherein the third feedback indication further comprises a visual feedback indication.

10. The computer-implemented method of claim 1, wherein the first feedback indication, the second feedback indication, and the third feedback indication are provided independent of a display device associated with the user computing device.

11. The computer-implemented method of claim 1, further comprising:
receiving, by the user computing device, one or more signals indicative of a presence of the user within a third interaction zone; and
determining, by the user computing device, a motion profile associated with the user based at least in part on the one or more signals indicative of the user in the presence of the user in the third interaction zone.

12. The computer-implemented method of claim 11, wherein the third interaction zone is a far interaction zone, the first interaction zone is an intermediate interaction zone, and the second interaction zone is a near interaction zone.

13. The computer-implemented method of claim 1, further comprising determining, by the user computing device, a motion profile associated with the user while the user is present in the second interaction zone; and
wherein determining, by the user computing device, a control gesture performed by the user comprises comparing, by the user computing device, a motion of the user to a predetermined control gesture based at least in part on the determined motion profile.

14. The computer-implemented method of claim 13, wherein determining, by the user computing device, the motion profile comprises determining velocity data and location data associated with the user over one or more time periods.

15. The computer-implemented method of claim 14, wherein determining, by the user computing device, the motion profile comprises determining one or more changes in velocity or one or more changes in position of the user.

16. The computer-implemented method of claim 1, wherein determining, by the user computing device, a control gesture performed by the user while in the second interaction zone comprises determining a control gesture performed by a control article associated with the user while in the second interaction zone.

17. A computing system, comprising:
one or more processors; and
one or more memory devices, the one or more memory devices storing computer-readable instructions that when executed by the one or more processors cause the one or more processors to perform operations, the operations comprising:
receiving one or more signals indicative of a presence of a user within a first interaction zone proximate the user computing device;
providing a first feedback indication based at least in part on the one or more signals indicative of a presence of the user within the first interaction zone;
receiving one or more signals indicative of a presence of the user within a second interaction zone proximate the user computing device;
providing a second feedback indication based at least in part on the one or more signals indicative of the presence of the user within the second interaction zone;
determining a control gesture performed by the user while in the second interaction zone; and
providing a third feedback indication based at least in part on the determined control gesture.

18. The computing system of claim 17, the operations further comprising:
identifying one or more actions to be performed based at least in part on the determined control gesture; and
performing the one or more actions.

19. One or more tangible, non-transitory computer-readable media storing computer-readable instructions that when executed by one or more processors cause the one or more processors to perform operations, the operations comprising:
receiving one or more signals indicative of a presence of a user within a first interaction zone proximate the user computing device;
providing a first feedback indication based at least in part on the one or more signals indicative of a presence of the user within the first interaction zone;
receiving one or more signals indicative of a presence of the user within a second interaction zone proximate the user computing device;
providing a second feedback indication based at least in part on the one or more signals indicative of the presence of the user within the second interaction zone;
determining a control gesture performed by the user while in the second interaction zone; and
providing a third feedback indication based at least in part on the determined control gesture.

20. The one or more tangible, non-transitory computer-readable media of claim 19, the operations further comprising:
receiving one or more signals indicative of a presence of the user within a third interaction zone; and
determining a motion profile associated with the user based at least in part on the one or more signals indicative of the user in the presence of the user in the third interaction zone.
